(19) United States
(12) Patent Application Publication
(10) Pub. No.: US 2003/0095108 A1
(43) Pub. Date: May 22, 2003

(54) Pointing, input and calculation apparatus

(76) Inventors: Hung-Wen Wang, Keelung (TW); Chen-Ming Wu, Keelung (TW); Hung-Chi Lin, Keelung (TW); Han-Tsou Chen, Keelung (TW); Kuo-Ching Hsieh, Keelung (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/990,973

(22) Filed: Nov. 20, 2001

(51) Int. Cl. G09G 5/00

(52) U.S. Cl. 345/169

(57) ABSTRACT

A pointing, input and calculation apparatus consists of a pointing module, an input module, a calculation module and a display module. The pointing module is capable of transmitting cursor-related data. The input module is capable of transmitting data related to numbers and symbols of algorithm. The calculation module is capable of performing calculation based on data received from the input module. The display module is capable of showing data provided through the input module and data provided from the calculation module.

### BACKGROUND OF INVENTION

1. Field of Invention

This invention is directed to a pointing, input and calculation apparatus including a pointing module, an input module, a calculation module and a display module.

2. Related Prior Art

A computer is often used to process data transmitted thereto through a proper device such as a keyboard and a mouse. A user often lays his or her hands near the keyboard in order to press the keys. When intending to move the cursor, the user moves one hand from the keyboard to the mouse. Moving the hand between the keyboard and the mouse may cause inconvenience for the user, thus reducing the efficiency of working and increasing the possibility of pressing a wrong key. This is particularly true for a user who has to move his or her hand between the keyboard and the mouse very often, for example, a bank teller who can do most of his or her jobs by using numeral keys on the keyboard and the mouse.

In addition, to check results from calculation performed in the environment, the user is very likely to use a calculator to calculate again. Hence, the user has t keep a calculator on his or her desk for occasional use. It could be depressing for someone working busily with documents piled on a disk to try to find the calculator.

### SUMMARY OF INVENTION

Hence, the primary objective of the present invention is to provide a pointing and input apparatus through which cursor-related signals and alphanumeric data can be transmitted to a computer or the like. The pointing and input apparatus includes a pointing module and an input module. The pointing module is used to transmit cursor-related signals. The input module is used to transmit alphanumeric data.

It is another objective of the present invention to provide a pointing, input and calculation apparatus. The pointing, input and calculation apparatus includes a pointing module, an input module and a calculation module. The pointing module is used to transmit cursor-related signals. The input module is used to transmit alphanumeric data. The calculation module is used to perform calculation based on the alphanumeric data received from the input module.

### BRIEF DESCRIPTION OF THE DRAWINGS

FIG. 1 is a perspective view of a conventional keyboard and a pointing, input and calculation apparatus in accordance with the present invention; and

FIG. 2 is a block diagram of a circuit used in the pointing, input and calculation apparatus in accordance with the present invention.

### DETAILED DESCRIPTION OF PREFERRED EMBODIMENT

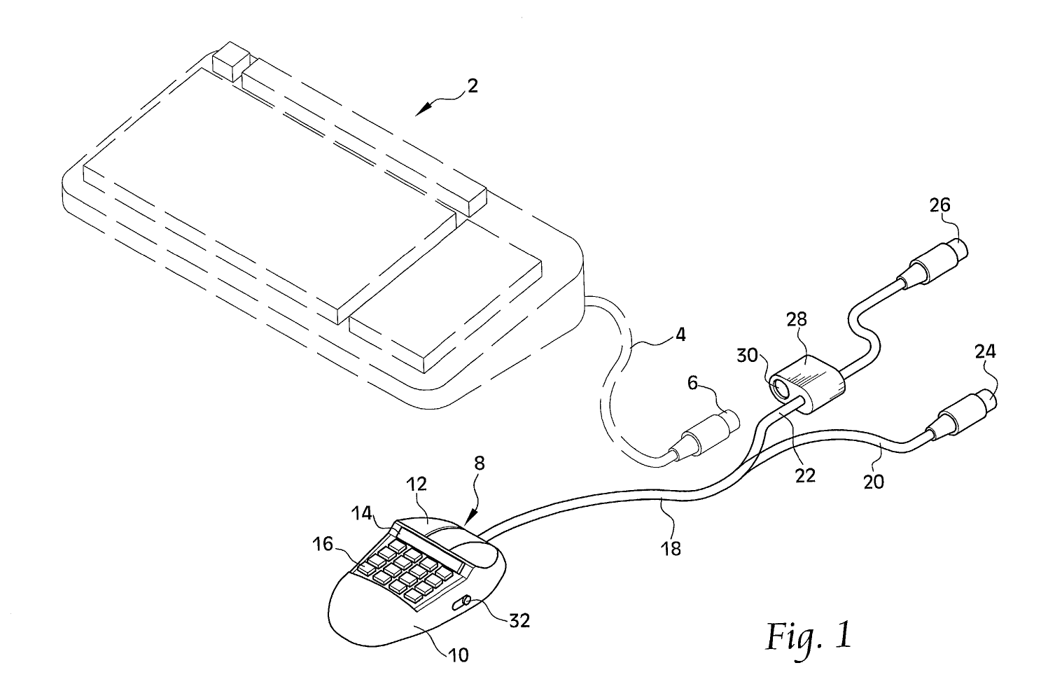

Referring to FIG. 1, a keyboard 2 according to prior art and a pointing, input and calculation apparatus 8 in accordance with the present invention are shown.

The keyboard 2 is conventional and does not constitute the spirit of the present invention. Therefore, keyboard 2 is not described in detailed except for its connection with the pointing, input and calculation apparatus 8 in accordance with the present invention. The keyboard 2 includes a sheath 4 and a plug 6. The sheath 4 contains a pair of wires (not shown). The plug 6 can be connected with the pointing, input and calculation apparatus 8 in a manner to be described.

The pointing, input and calculation apparatus 8 includes a pointing module, an input module, a calculation module and a display module.

Referring to FIG. 1, the pointing, input and calculation apparatus 8 includes a casing 10. The casing 10 is similar to that of a conventional mouse except for a back designed for the present invention. The back of the casing 10 consists of first, second and third segments. The second segment descends abruptly from the first segment to the third segment.

Several buttons 12 are mounted on the first segment of the back of the casing 10. In both structure and function, the buttons 12 are identical to that of any conventional mouse and therefore are not described in further detail.

A display 14 is mounted on the second segment of the casing 10. The display 14 is preferably a flat panel display and, more particularly, a liquid crystal display. The display 14 is positioned in a plane at an angle from a vertical plane so that information showed thereby can be easily observed by a user of the pointing, input and calculation apparatus 8.

A number of keys 16 are mounted on the third segment of the back of the casing 10. The keys 16 are identical to the keys (not shown) of the convention keyboard 2 in both structure and function, and therefore are not described in further detail.

Ergonomically, when operating the pointing, input and calculation apparatus 8, the user presses the casing 10 on a side with the thumb and on an opposite side with the nameless finger and the little finger, thus clamping the casing 10. The other fingers rest on the buttons 12. The user's forehand and a portion of palm rest on the desk. Thus, the user's hand forms an arch. Due to the arch formed of the user's hand and the specially designed back of the casing 10, the user tends not to press the keys 16 by mistake while operating the pointing, input and calculation apparatus 8.

A sheath 18 extends from the casing 10 and diverges into two branches 20 and 22. Two pairs of wires (not depicted) are enclosed in the sheath 18, with a first pair extending into the branch 20 and a second pair extending into the branch 22. The branch 20 terminates at a plug 24 while the branch 22 terminates at a plug 26.

The first pair of wires is connected with the pointing module in a manner to be described in detail. The plug 24 is identical to the plug of any conventional mouse in both structure and function.

The second pair of wires is connected with the input module in a manner to be described in detail. The plug 26 is identical to the plug of any conventional keyboard (the plug 6 of the keyboard 2, for example) in both structure and function.

At a point in the branch 22, there is formed a connector 28 with a socket 30 for engagement with the plug 6 of the keyboard 2. Thus, the keyboard 2 of prior art and the input module of the pointing, input and calculation apparatus 8 in accordance with the present invention can both be connected to a host computer H.

On a side of the casing 10, there is formed a switch 32 which can be operated so as to switch the pointing, input and calculation apparatus 8 between an input mode and a calculation mode in a manner to be described in detail.

Pointing Module

The pointing module of the present invention is identical to any conventional mouse (mechanical type or optical type) in both structure and function and, hence, is described briefly.

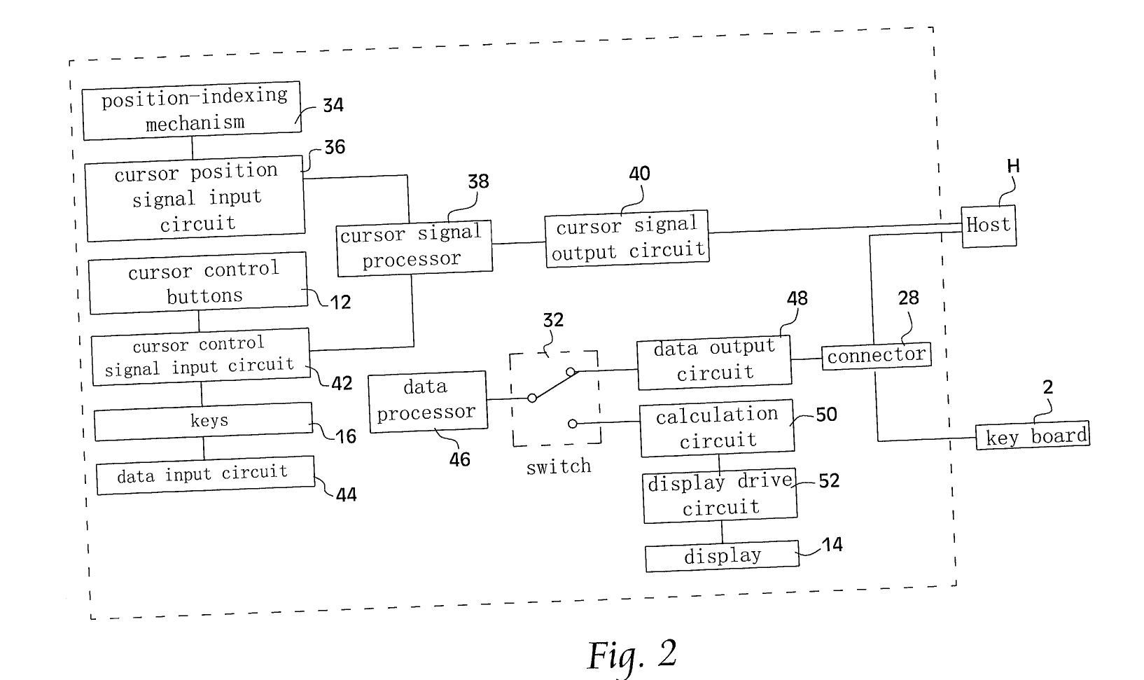

Referring to FIGS. 1 and 2, the pointing module includes a position-indexing mechanism 34, a cursor position signal input circuit 36, a cursor signal processor 38, a cursor signal output circuit 40, the cursor control buttons 12 and a cursor control signal input circuit 42.

The position-indexing mechanism 34 is partly exposed to the exterior of the casing 10 through a hole defined in a bottom of the casing 10. The position-indexing mechanism 34 is used to produce a cursor position signal based on its position with respect to a reference plane such as a desk surface. The cursor position signal is transmitted from the position-indexing mechanism 34 through the cursor position signal input circuit 36 to the cursor signal processor 38.

When any of the cursor control buttons 12 is pressed, a cursor control signal is produced and transmitted through the cursor control signal input circuit 42 to the cursor signal processor 38.

The circuit 38 is designed to process the cursor position signal and the cursor control signal in a conventional way and transmit them to the cursor signal output circuit 40. The cursor signal output circuit 40 is connected with the first pair of wires that is enclosed in the sheath 18 and branch 20. The branch 20 is connected to a plug 24. The plug 24 can be engaged with a socket of the host H for a mouse. Thus, the cursor position signal and the cursor control signal can be transmitted to the host H.

Input Module

The keys 16, a data input circuit 44, a data processor 46, a data output circuit 48 and a connector 28 together constitute the data input module.

In a preferred embodiment of the present invention, the keys 16 are identical to keys that can be found in the rightmost portion of a conventional keyboard in function and structure. Data can be entered to the host H by pressing the keys 16. The data are transmitted to the data processor 46 through the data input circuit 44. The data processor 46 is designed to process the data in a conventional way and transmit them to the data output circuit 48. The data output circuit 48 is connected to the second pair of wires. The branch 22 is connected to the connector 28. The plug 6 of the keyboard 2 can be engaged with the socket 30 of the connector 28. thus connecting the pair of wires contained in the sheath 4 with the second pair of wires in parallel. The second pair of wires extends beyond the connector 28 and is connected to the plug 26. The plug 26 can be engaged with a socket of the host II for a keyboard. Thus, data can be transmitted to the host H through the keyboard 2 of prior art or the input device 16 of the present invention.

Calculation Module

The calculation module includes a plurality of keys 16, a data input circuit 44, a data processor 46, a calculation circuit 50, a display drive circuit 52 and a display 14.

The calculation circuit 50 and the display drive circuit 52 are formed in the casing 10. Data, particularly alphanumeric and algorithm symbols, are transmitted from keys 16, through the data input circuit 44 and the data processor 46 to the calculation circuit 50. The calculation circuit 50 is designed to calculate these data and transmit result of calculation to the display drive circuit 52. The display drive circuit 52 is designed to process and show the result of calculation on the display 14.

Mode Switch

In the embodiment shown in the drawings, the data processor is connected via the switch 32 to the data output circuit 48 and the calculation circuit 50. Therefore, the switch 32 can be operated so as to switch the input device between the input mode and the calculation mode.

1. An input device comprising:
a pointing module for transmitting signals related to a cursor; and
a data input module for transmitting data.

2. An input device in accordance with claim 1 wherein the data input module is used to transmit data related to numerals.

3. An input device in accordance with claim 2 wherein the data input module is used to transmit data related to numerals and symbols.

4. An input device according to claim 3 wherein the data input module comprises:
a plurality of data input keys;
a data input circuit connected to the data input keys;
a data processor connected to the data input circuit;
a connector connected to the data processor and including a socket for engagement with a plug of a keyboard; and
a plug connected to the connector and adapted for engagement with a socket of a host for a keyboard.

5. A pointing, input and calculation apparatus comprising:
a pointing module for transmitting signals related to a cursor;
a data input module for transmitting data including numerals and algorithm symbols; and
a calculation module for receiving data from the data input module and calculating the data and showing result of calculation.

6. A pointing, input and calculation apparatus in accordance with claim 5 wherein the data input module comprises:
a plurality of data input keys;
a data input circuit connected to the data input keys;
a data processor connected to the data input circuit;
a connector connected to the data processor and including a socket for engagement with a plug of a keyboard; and
a plug connected to the connector and adapted for engagement with a socket of a host for a keyboard.

7. A pointing, input and calculation apparatus in accordance with claim 6 wherein the calculation module comprises:
a plurality of data input keys;
a data input circuit connected to the data input keys;
a data processor connected to the data input circuit;
a calculation circuit connected to the data input circuit;
a display; and
a display drive circuit connected between the calculation circuit and the display.

8. A pointing, input and calculation apparatus in accordance with claim 7 comprising a switch connected with the data processor at one end and connected with one of the data output circuit and the calculation circuit at another end.
